(19) United States
(12) Patent Application Publication
(10) Pub. No.: US 2025/0071013 A1
(43) Pub. Date: Feb. 27, 2025

(54) METHODS AND SYSTEMS FOR AUTONOMOUS RECOVERY OF NETWORK ACCESS

(71) Applicant: Edmond K. Chow, Hong Kong (HK)

(72) Inventor: Edmond K. Chow, Hong Kong (HK)

(21) Appl. No.: 18/237,895

(22) Filed: Aug. 24, 2023

(51) Int. Cl. H04L 41/0659; H04L 12/12

(52) U.S. Cl. CPC H04L 41/0659; H04L 12/12

(57) ABSTRACT

An invention is disclosed for systems, methods, processes, products and apparatuses of providing network access recovery through control of power supply. One or more aspects of such a system, method, process, or product may provide a reliable and efficient way to restore access to a network with minimal user intervention when the network access becomes unavailable or unacceptable.

### TECHNICAL FIELD

The present invention relates to systems, methods, processes, products and apparatuses of providing recovery for networked devices or network systems. In particular, embodiments of the present invention provide network access recovery through control of power supply.

### BACKGROUND

With digitalization of various societal domains such as education, commerce, entertainment, and government services, the importance of a reliable Internet connection has increasingly become an indispensable household utility, among other more traditional utility services such as electricity and telephone. Households without technology-savvy members tend to run into difficulties when their Internet access is slow or unavailable. Even technology-savvy people could do little when that happens, if they are away from home or office where Internet access is relied upon for their digital or communication needs, such as security surveillance and remote access. In addition, there are often a plurality of networked devices in the premises, where some may fail to recover properly from being disconnected from the Internet unless the modem and one or more routers there have first recovered from an outage, such as a power outage.

### SUMMARY

According to one embodiment, a method or system is provided or configured for determining if access to or via a network is unacceptable in relation to a criterion, such as loss of network connectivity, inaccessibility to a host or server on or via the network, excessive delay in responses from a host or server on or via the network, or download and/or upload speeds below certain criteria. For example, a device equipped with one or more aspects of the present invention may store applicable acceptability criteria as well as the address or location information of one or more hosts or servers with which it can access periodically the hosts or servers on or via the network to evaluate access acceptability. For example, at each attempt for access, the device may test one or more criteria such as reachability, latency in responses, and/or upload/download speeds. In one embodiment, an acceptability criterion may be provided directly by a user on the device capable of receiving such user input, either wirelessly or by tactile input. In another embodiment, the acceptability criteria may be provided by a server on or via the network that the device is monitoring for access acceptability.

The method or system is also provided or configured for causing a power supply to be unavailable or insufficient, such as disabling the power supply, or reducing the level of power supply so to be undetectable or inoperable for a communication device, thereby rendering the communication device to an off state. For example, a device equipped with one or more aspects of the present invention may disable or turn off one or more electrical outlets it possesses or controls when an applicable acceptability test has failed once or multiple times within a pre-defined or user-provided period of time.

The method or system is also provided or configured for causing a power supply to be available or sufficient. In one embodiment, the power supply is caused to be available or sufficient by re-enabling the power supply, or making the level of power supply to be detectable or operable to a communication device that relies on the power supply, thereby turning on or restarting the communication device. In another embodiment, a device equipped with one or more aspects of the present invention may resume its access acceptability monitoring after a predefined or user-provided period of time since the restart.

### OBJECTS AND ADVANTAGES

An embodiment of the present invention enables recovery of network access in a reliable way with minimal user intervention. For example, in one embodiment, a device equipped with one or more aspects of the present invention may detect problems with access to the Internet, such as loss of connectivity to a Wi-Fi through which the Internet has been accessed, or slow download/upload speeds or unresponsiveness with one or more pre-selected hosts or servers on the Internet. In one embodiment, such a device may then disable power supply to one or more electrical outlets into and from which one or more modems and routers are plugged and power-supplied, where the one or more modems and routers have been configured to provide access to the Internet. In one embodiment, such a device may re-enable power supply to the electrical outlets one after another so to restart the affected modems and routers in a sequence that facilitates a more proper or effective recovery process. In one embodiment, the parameters or criteria for such re-enablement of power supply may be pre-defined in the device or pre-arranged by a user, or a combination thereof. When the network access has been re-established, the device may resume its normal monitoring process or schedule. No manual intervention is needed from detecting network access issues to triggering recovery and resuming monitoring.

There may be other objects and advantages. The present disclosure including the drawings would make them apparent to one of ordinary skill in the art.

### BRIEF DESCRIPTION OF THE DRAWINGS

FIG. 1 illustrates an example environment for an embodiment of the present invention.

FIG. 2 illustrates an example block diagram illustrating components of a device in accordance with an embodiment of the present invention.

FIG. 3 illustrates another example block diagram illustrating components of a device in accordance with an embodiment of the present invention.

FIG. 4 illustrates a flow diagram of an example process for an embodiment of the present invention.

FIG. 5 illustrates a flow diagram of another example process for an embodiment of the present invention.

FIG. 6 illustrates a flow diagram of yet another example process for an embodiment of the present invention.

FIG. 7 illustrates a flow diagram of a fourth example process for an embodiment of the present invention.

FIG. 8 illustrates a flow diagram of a fifth example process for an embodiment of the present invention.

### DETAILED DESCRIPTION OF ILLUSTRATIVE EMBODIMENTS

Disclosed are methods, systems, processes, products and apparatuses for monitoring network connectivity or accessibility, and performing recovery from an unavailable or unacceptable connection or access with minimal manual intervention. For instance, described is a method or system that determines if access to or via a network is unacceptable in relation to a criterion, such as loss of network connectivity, inaccessibility to a host or server on or via the network, excessive delay in responses from a host or server on or via the network, and/or download/upload speeds below certain criteria. Such a method or system may store applicable acceptability criteria as well as the address or location information of one or more hosts or servers with which it can access periodically the hosts or servers on or via the network to evaluate access acceptability. For example, at each attempt for access, the device may test one or more criteria such as reachability, latency in responses, or upload/download speeds. In one embodiment, an acceptability criterion may be provided directly by a user on the device capable of receiving such user input, either wirelessly or by tactile input (e.g., buttons on the device). In another embodiment, the acceptability criteria may be provided by a server on or via the network that the device is monitoring for access acceptability. Such a method or system may cause a power supply to be unavailable or insufficient, such as disabling the power supply, or reducing the level of power supply so to be undetectable or inoperable for a communication device, thereby rendering the communication device to an off state. For example, a smart electrical power supply or plug equipped with the present invention may disable or turn off one or more electrical outlets it possesses or controls when an applicable acceptability test has failed once or multiple times within a pre-defined or user-provided period of time. Such a method or system may then cause the power supply to be available or sufficient in relation to another criterion. In one embodiment, this other criterion may be a period of time after the power supply was intentionally disabled or made insufficient. In another embodiment, this other criterion may entail receiving an indication, from an external server or service, that the network assess has been restored. In one embodiment, to cause the power supply to be available or sufficient, such a method or system may re-enable one or more electrical outlets from which one or more communication devices obtain their power, thereby turning on or restarting these communication devices (e.g., modems and routers) that may be responsible for the network access. Afterwards, such a method or system may resume its access acceptability monitoring immediately, or after a predefined or user-provided period of time.

In one embodiment, a method, system, process, product and apparatus equipped with one or more aspects of the invention may detect problems with access to the Internet, such as loss of connectivity to a Wi-Fi through which the Internet has been accessed, or slow download/upload speeds or unresponsiveness with one or more pre-selected hosts or servers on the Internet. In one embodiment, such a device may then disable power supply to one or more electrical outlets into and from which one or more modems and routers are plugged or power-supplied, where the one or more modems and routers are responsible for access to the Internet. In one embodiment, such a device may re-enable power supply to the electrical outlets one after another so to restart the affected modems and routers in a sequence that facilitates a more proper or efficient recovery process. In one embodiment, the parameters or criteria for such re-enablement of power supply may be pre-defined in the device or pre-arranged by a user, provided on demand by an external server or service, or a combination thereof. When the network access has been re-established, the device may resume its normal monitoring process or schedule. In one embodiment, such parameters or criteria along with the configuration information for testing access acceptability may all be stored in a device equipped with one or more memories, and the device may perform its intended operations or functions without the need for network access.

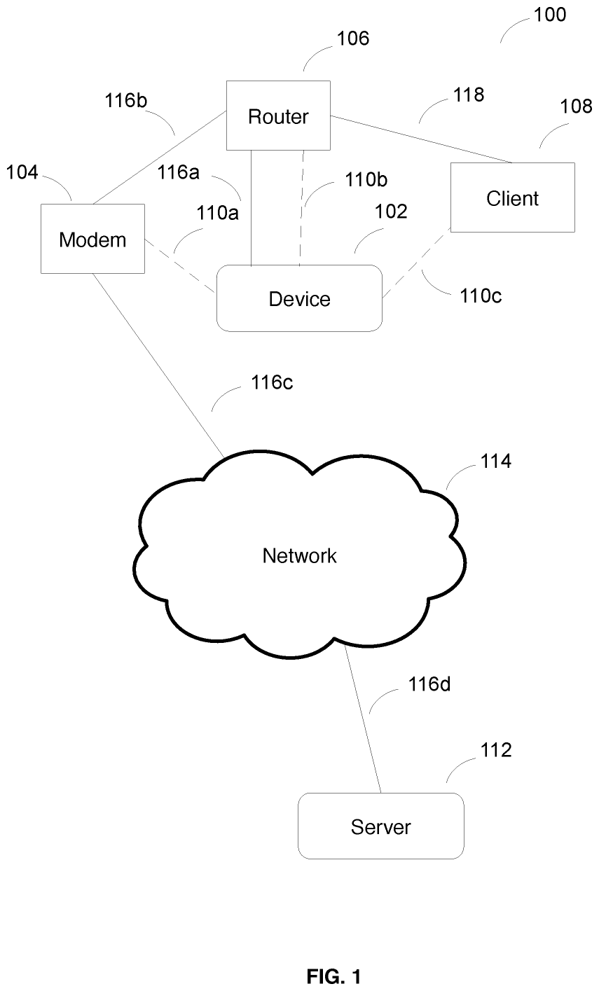

FIG. 1 illustrates an exemplary environment 100 for an embodiment of the present invention. For instance, device 102 may comprise a plurality of electrical outlets, into which modem 104, router 106 and client 108 are plugged for power supply 110a-110c. Device 102 may make or maintain connectivity with server 112 on or via network 114 as a means to monitor and assess one or more network access acceptability criteria. For example, device 102 may initiate communications or otherwise receive indications from server 112 through one or more connections 116a-116d so to determine if network accessibility is unacceptable or not. Client 108 may also access the network via router 106 and modem 104 where, for example, connection 118 between client 108 and router 106 is wireless such as Wi-Fi (e.g., one associated with a service set identifier-SSID), connection 116b between router 106 and modem 104 is wired such as Ethernet, and connection 116c between modem 104 and network 114 involves DSL (Digital Subscriber Line) services.

In one embodiment, a device such as device 102 may be pre-configured with a uniform resource locator (URL) of a server such as server 112. The device may comprise at least three electrical outlets, each of which is identified by or otherwise associated with a unique number among a sequence of numbers starting from one, for example, “1”, “2”, and “3” for three outlets. The device may store in one or more memories time information that provides a basis to determine, for instance, how frequent to check for access acceptability, and how long to wait before re-enabling individual electrical outlets. For example, the device may be communicatively connected to a port on a router such as router 106 while the router is plugged into the outlet identified by “2”. The router may provide access to the Internet via a modem such as modem 104, and the modem is plugged into the outlet identified by “1”. A client device such as client 108 is communicatively connected to the router for access to the Internet and plugged into the outlet identified by “3”. In one embodiment, upon being powered up or activated, the device may wait for a pre-defined period of time in accordance with the time information stored in the one or more memories, and then proceed to contact the server based on the pre-configured URL information. If accessibility to the server is deemed acceptable, the device will wait again before repeating the access acceptability test. If later the test fails, the device may disable all three outlets. In one embodiment, the device may wait for another pre-defined period of time and re-enable the power outlet identified by “1”. It may then wait for yet another pre-defined period of time and re-enable the power outlet identified by “2”. The device may then perform one or more access acceptability tests and decide if the access is acceptable. If so, it may re-enable the power outlet identified by “3”. Otherwise, it may disable the two power outlets identified by “1” and “2” respectively. In one embodiment, such a device, setup or system may possess all the necessary configuration information as its factory settings to provide automatic network access monitoring and recovery, all without the need for any user configuration or intervention prior to the activation or during the operation of the device. In one embodiment, such a device may receive updates or changes to any or all of its locally stored configuration information through the same network, or one that is different from the network that it monitors for connectivity or accessibility.

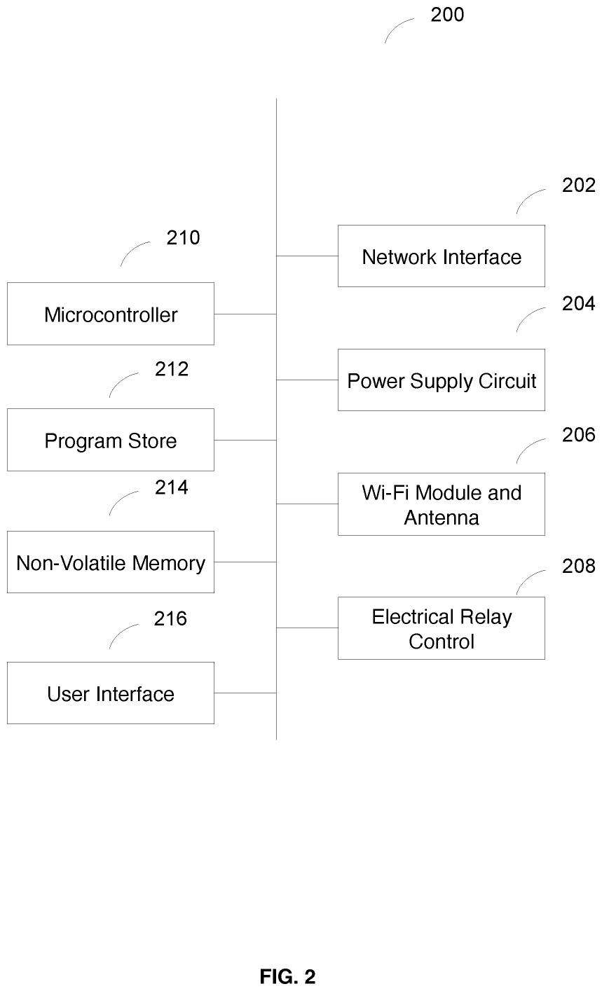

FIG. 2 shows an example block diagram 200 illustrating components of a device in accordance with an embodiment of the present invention. For instance, a device such as device 102 may comprise network interface 202, power supply circuit 204, Wi-Fi module and antenna 206, electrical relay control 208, microcontroller 210, program store 212, non-volatile memory 214, and on-device I/O 216. In one embodiment, network interface 202 provides one or more points of interaction or communication between the device and a network or a networking device. For example, it may enable the connection and communication between the device and a router via Ethernet. Power supply circuit 204 converts the main AC power to the lower DC voltages required by other components in the device. Wi-Fi Module and Antenna 206 may allow the device to communicate wirelessly with a Wi-Fi capable router for access to the network, or an app on a mobile phone to configure the device. Electrical relay control 208 can turn or control on or off, allowing or interrupting the flow of electricity to individual outlets on the device. Such an electrical relay can be activated or deactivated by microcontroller 210 based on instructions (e.g., firmware) found in program store 212 and configuration information or parameters stored in non-volatile memory 214. Microcontroller 210 may also interpret and execute commands stored in program store 212 or received from a user or a network. It also manages the overall functioning of the device, including communication with other components. User Interface 216 may comprise one or more components that interact or otherwise communicate directly with a user or an external environment, such as a button or a display. It is to be noted that a device equipped with one or more aspects of the present invention may omit one or more components in FIG. 2, or a component may have more or less functionality as described. For example, such a device may not possess a user interface component. Wi-Fi Module and Antenna 205 could be split into two separate components. Additionally, FIG. 2 is not intended to provide an exhaustive list of components. For example, a printed circuit board (PCB), not shown in FIG. 2, could be considered a component, which provides electrical connections among components and is where they are mounted. One of ordinary skill in the art would readily appreciate the illustrative nature of FIG. 2 and the disclosure pertaining to it.

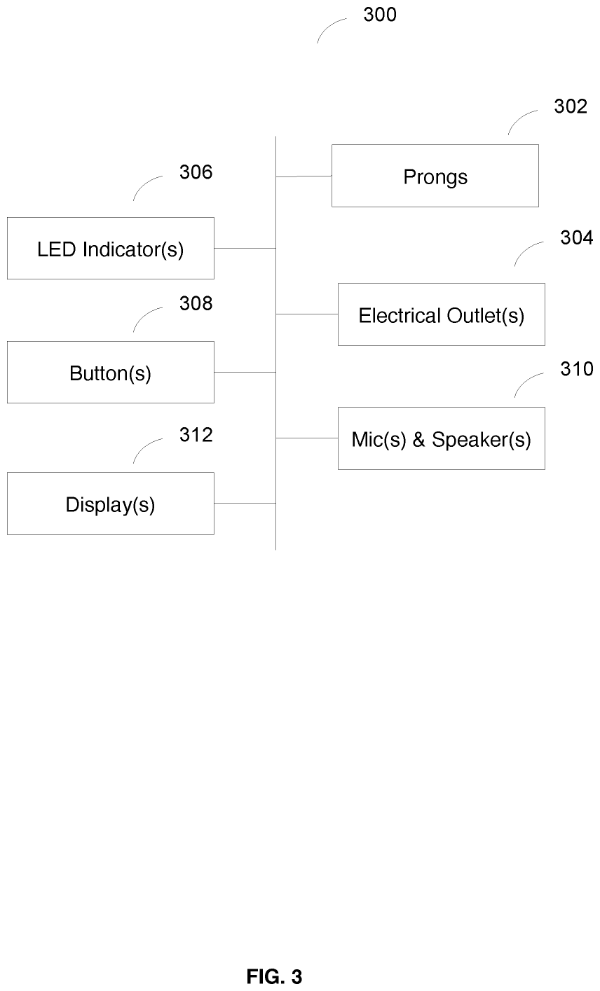

FIG. 3 shows another example block diagram 300 illustrating components of a device in accordance with an embodiment of the present invention. For instance, a device such as device 102 may comprise the following externally visible physical components: prongs 302, electrical outlet(s) 304, LED indicator(s) 306, button(s) 308, mic(s) and speaker(s) 310, and display(s) 312. In one embodiment, prongs 302 plug into the main AC power. Electrical outlet(s) 304 receive the plugs of the communication devices whose power supply can be disabled or enabled through the control of these electrical outlet(s). LED indicator(s) 306 may indicate statuses, such as power, connectivity, or activity. Button(s) 308 may act as receivers for manual intervention or user input, such as performing a reset or wirelessly pairing the device with another device such as a mobile phone. Mic(s) and speaker(s) 310 enable audio input and output, such as audible alerts or notifications and voice control and response. Display(s) 312 enable graphical or textual notifications and messages. Touchscreens may also allow for tactile input in addition to or in lieu of buttons, if any. It is to be noted that a device equipped with one or more aspects of the present invention may omit one or more externally visible physical components in FIG. 3, or a component may have more or less functionality as described. For example, an enclosure or casing, not shown in FIG. 3, could be regarded as an externally visible physical component that holds other components. Additionally, FIG. 3 is not intended to provide an exhaustive list of externally visible physical components. For example, a device may comprise an Ethernet port for wired connection to a router or use external antennas instead of internal ones which are built or installed inside the enclosure or casing.

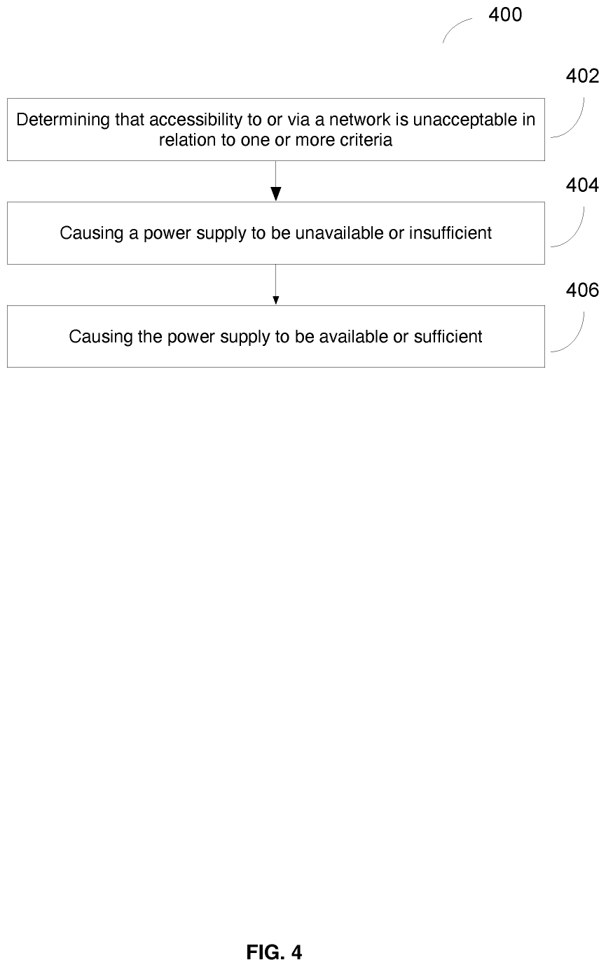

FIG. 4 shows a flow diagram of an exemplary process 400 for network access recovery in accordance with an embodiment of the present invention. A device or system embodying the present invention or otherwise equipped with the present invention, such as one shown in FIG. 1, FIG. 2, and/or FIG. 3, may carry out, implement, or otherwise effect this exemplary process. Per the example process 400, such a device or system may determine that accessibility to or via a network is unacceptable in relation to one or more criteria (402). For instance, an example criterion is that a server or host on the Internet be reachable via one or more protocols from among the Internet protocol suite, such as HTTP (Hypertext Transfer Protocol) or ICMP (Internet Control Message Protocol), and the device or system may periodically perform a request based on these one or more protocols to access the server or host. The server or host address (e.g., IP address) or location (e.g., URL) and time information for determining the periodicity may be stored in or otherwise accessible to the device or system.

Per the example process 400, the device or system may cause a power supply to be unavailable or insufficient, for instance, when it determines that the network access is unacceptable (404). For example, the device or system may perform the accessibility determination via a Wi-Fi network serving as a gateway or local area network (LAN) communicatively coupled with the Internet. In one embodiment, a modem, a router or a modem-router combo is plugged into an electrical outlet, and the modem, router or modem-router combo enables the device or system to access the Internet via the Wi-Fi network. The device or system may disable the electrical outlet upon determining that a specific server is not reachable via one or more protocols from among the Internet protocol suite.

Per the example process 400, the device or system may cause the power supply to be available or sufficient (406). For instance, the device or system may re-enable the previously disabled electrical outlet to which the modem and/or router is plugged for power. In one embodiment, the device or system may re-enable the outlet in relation to some criterion. An example criterion is a wait time in relation to the power supply being disabled. In one example, the device or system may re-enable the power supply after the wait time and perform an access acceptability test soon after that. In yet another embodiment, the device or system may receive an asynchronous message or unsolicited indication from the server or host with which it conducts access acceptability testing, or a different server or host. The device or system may determine that the network access is acceptable in relation to the receipt of such a message or indication.

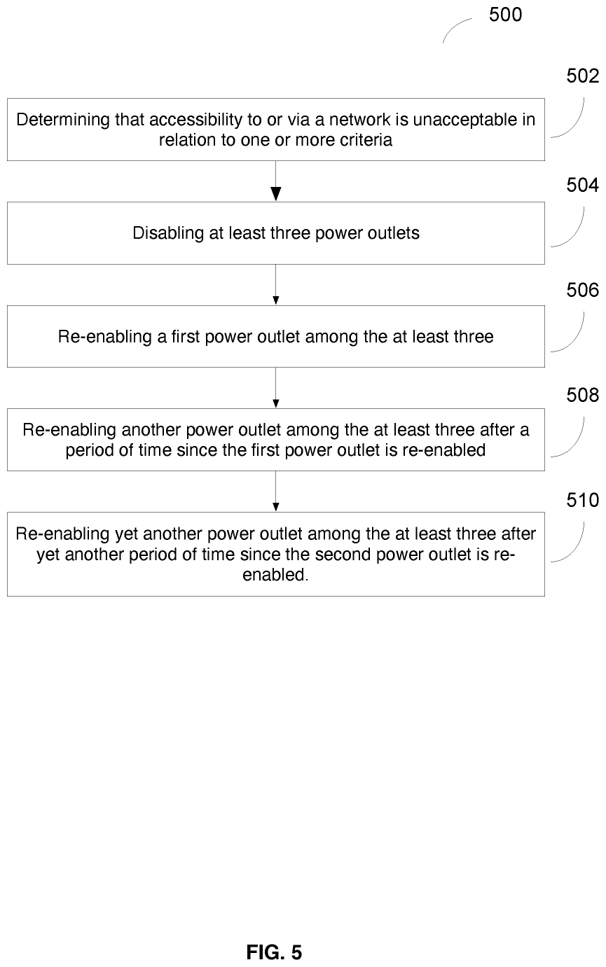

FIG. 5 shows a flow diagram of an exemplary process 500 for network access recovery in accordance with an embodiment of the present invention. A device or system embodying the present invention or otherwise equipped with the present invention, such as one shown in FIG. 1, FIG. 2, and/or FIG. 3, may carry out, implement, or otherwise effect this exemplary process. Per the example process 500, such a device or system may determine that accessibility to or via a network is unacceptable in relation to one or more criteria (502). For instance, the device or system after being powered up and communicatively coupled with the network may receive configuration information from a host or server on the network, such as the Internet. The configuration information may contain parameters related to server addresses or locations for testing network accessibility, and to time intervals for such testing and for re-enabling power supply. After storing in a non-volatile memory such configuration information, for example, during manufacturing of the device or system, or as part of powered-up initialization, the device or system will be sufficiently configured to perform its intended operations even when the network access that the device or system is monitoring for recovery is subsequently unavailable. In one example, the device or system may test for access acceptability by sending a Ping message to or assessing download and upload speeds with a server on the network, after a period of time has passed, such as after the device or system having been powered up. The device or system may maintain a timer that works independently of any access to the network under monitoring. In one example, the device or system may determine network access acceptability based on a percentage of a reference download or upload speed, the percentage being a criterion among the configuration information. The device or system may determine a reference speed with an external server on the network, from a user, or a combination of both. For example, the device or system may perform one or more speed tests and choose the fastest speed among the results as a reference speed, without any intervention or input from a user or an external server. In another example, the device or system may initially obtain an indication (e.g., via a physical button or on a mobile app) from a user that the current speed as presently observed by the user and/or as measured by the device or system is acceptable. A reference speed may then be determined accordingly. In one embodiment, the device or system may update a current reference speed whenever it detects a faster speed during its continual speed tests. A threshold speed below which the network access is deemed unacceptable may be a percentage of the latest reference speed.

Per the example process 500, the device or system may disable at least three power outlets (504). For instance, upon deciding that the network access is unacceptable, the device or system may disable three outlets that the device or system may comprise or otherwise control, where for example, a modem may be plugged in one of the three outlets, a router in another, and a networked camera in the third.

Per the example process 500, the device or system may re-enable one of the at least three power outlets (506). For instance, after some wait time or a pre-determined period of time since the disabling of the power outlets, the device or system may turn on or re-enable the power outlet in which the modem may be plugged. In one embodiment, the power outlet may be identified by a numerical number such as “1” or a graphical icon suggesting a modem, which appears next to the power outlet, or on a graphical user interface associated with a mobile app.

Per the example process 500, the device or system may re-enable another of the at least three power outlets (508). For instance, after some wait time or a pre-determined period of time since the earlier re-enabling of the first power outlet, the device or system may turn on or re-enable the power outlet in which the router may be plugged. In one embodiment, the power outlet may be identified by a numerical number such as “2” or a graphical icon suggesting a router, which appears next to the power outlet, or on a graphical user interface associated with a mobile app.

Per the example process 500, the device or system may re-enable yet another of the at least three power outlets (510). For instance, after some wait time or a pre-determined period of time since earlier re-enabling of the second power outlet, the device or system may turn on or re-enable the power outlet in which the networked camera may be plugged. In one embodiment, the power outlet may be identified by a numerical number such as “3” or a graphical icon suggesting a client device, which appears next to the power outlet, or on a graphical user interface associated with a mobile app.

It should be appreciated that the specific steps illustrated in FIG. 5 provide an illustrative method of performing network access monitoring and recovery. One of ordinary skill in the art would readily be able to apply or otherwise modify it for use among different devices or systems or their setups, such as one where more than three power outlets are involved, or one where the configuration information for the device or system to perform network access monitoring and recovery is pre-set as part of the factory settings, obtained by manual input or user intervention, received over a network from an external server or host, or a combination thereof.

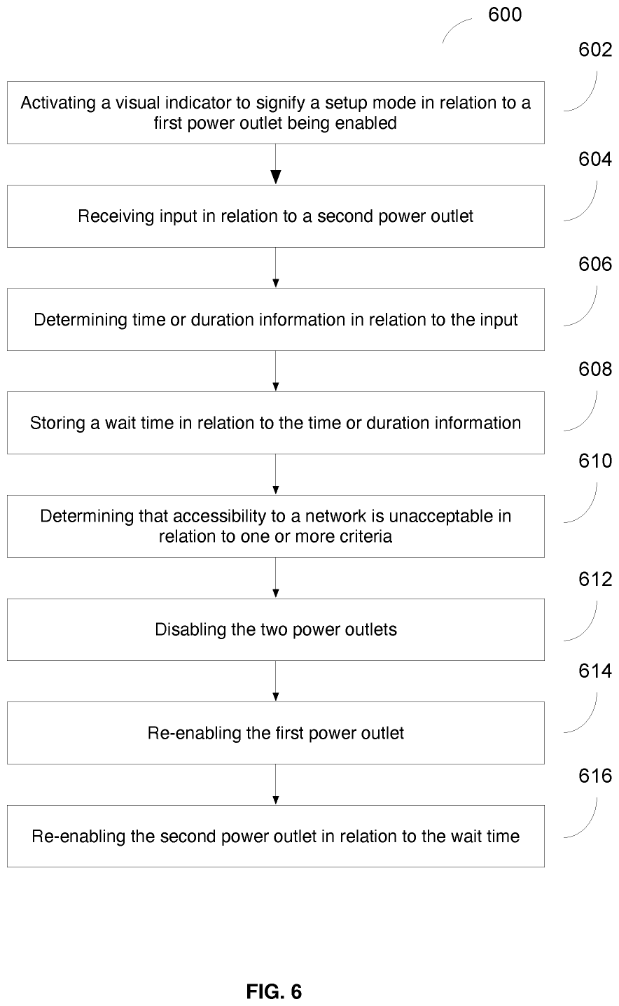

FIG. 6 shows a flow diagram of an exemplary process 600 for network access recovery in accordance with an embodiment of the present invention. A device or system embodying the present invention or otherwise equipped with the present invention, such as one shown in FIG. 1, FIG. 2, and/or FIG. 3, may carry out, implement, or otherwise effect this exemplary process. Per the example process 600, such a device or system may activate a visual indicator such as a LED (Light Emitting Diode) to signify a setup mode in relation to a first power outlet being enabled (602). For instance, a device or system (e.g., a power bar) equipped with one or more aspects of the present invention may have a LED associated with each of its power outlets. When one of the power outlets is turned on, for example, via a button next to the power outlet in question, the LEDs of the other power outlets may start blinking, for example, yellow. In one embodiment, the setup mode can be reset, for example, by a dedicated reset button on the device or system, or a combination of buttons with other purposes. For instance, when all the individual on/off buttons for the power outlets are turned off, for example, while the power supply to the device or system is still enabled or on, then the device or system may regard it as a request to reset the setup mode, where a user may start anew the setup process.

Per the example process 600, the device or system may receive input in relation a second power outlet. For instance, a user may turn on one of these other power outlets, for example, via a button next to that power outlet, and the device or system may cause the LED associated with the power outlet to display a steady light, for example, green.

Per the example process 600, the device or system may determine time or duration information in relation to the input (606). For instance, the device or system may calculate the time between the first power outlet and the second one being enabled.

Per the example process 600, the device or system may store a wait time in relation to the time or duration information (608). For instance, the device or system may derive a wait time, for example, add a buffer time or round it up to the next minute, based on the determined time or duration information, and store it in its non-violate memory for later retrieval, for example, when the device or system sets up a timer for re-enabling the second power outlet in relation to the first one in the aftermath of disabling both the power outlets due to unacceptable network accessibility.

Per the example process 600, the device or system may determine that accessibility to a network is unacceptable in relation to one or more criteria (610). For instance, the device or system may retrieve from the configuration information the address or location information of a server, and send a message to the server via a protocol, e.g., HTTP and/or ICMP from among the Internet protocol suite. Upon one ore multiple times of failing to receive a response or sampling upload/download speeds that are below a threshold or criterion (which may also be available from the configuration information), the device or system may determine or deem that the network accessibility is unacceptable.

Per the example process 600, the device or system may disable the two power outlets (612). For instance, upon deciding that the network access is unacceptable, the device or system may disable the two outlets that the device or system comprises or otherwise controls, where for example, an apparatus functioning as a modem and a wireless router may be plugged in the first power outlet and another device or system (e.g., another power bar) is plugged into the second power outlet. In one embodiment, the device or system may access the network under monitoring (e.g., the Internet) via a wireless router that is plugged into a power outlet controlled by the device or system. In one example, the configuration or access information pertaining to the wireless router may be part of the factory settings for the device or system. In another example, it may be obtained from an external server accessible from the network. Yet in another example, it may be provided by a user through a user interface on the device or system, or on a mobile app communicatively coupled with the device or system. It is to be noted an embodiment may comprise more than one way of providing the configuration information, and the embodiment may allow a combination of these different ways.

Per the example process 600, the device or system may re-enable the first power outlet (614). For instance, after some wait time or a pre-determined period of time since disabling the two power outlets, the device or system may turn on or re-enable the first power outlet that was first turned on during the setup process. In one embodiment, the device or system may wait for a period time based on a time interval between disabling the two power outlets and re-enabling the first one. In another embodiment, such a wait time may be derived from time intervals information stored in the device or system as part of the factory settings. In yet another embodiment, such a wait time may be sent from or otherwise provided by an external server beforehand, or provided by a user through a mechanical or networked interface.

Per the example process 600, the device or system may re-enable the second power outlet in relation to the wait time (616). For instance, the device or system may wait or delay for a period of time since the re-enabling of the first power outlet in accordance with the previously determined wait time, and then turn on or re-enable the second power outlet.

It should be appreciated that the specific steps illustrated in FIG. 6 provide an illustrative method of performing network access monitoring and recovery. One of ordinary skill in the art would readily be able to apply or otherwise modify it for use among different devices or systems or their setups.

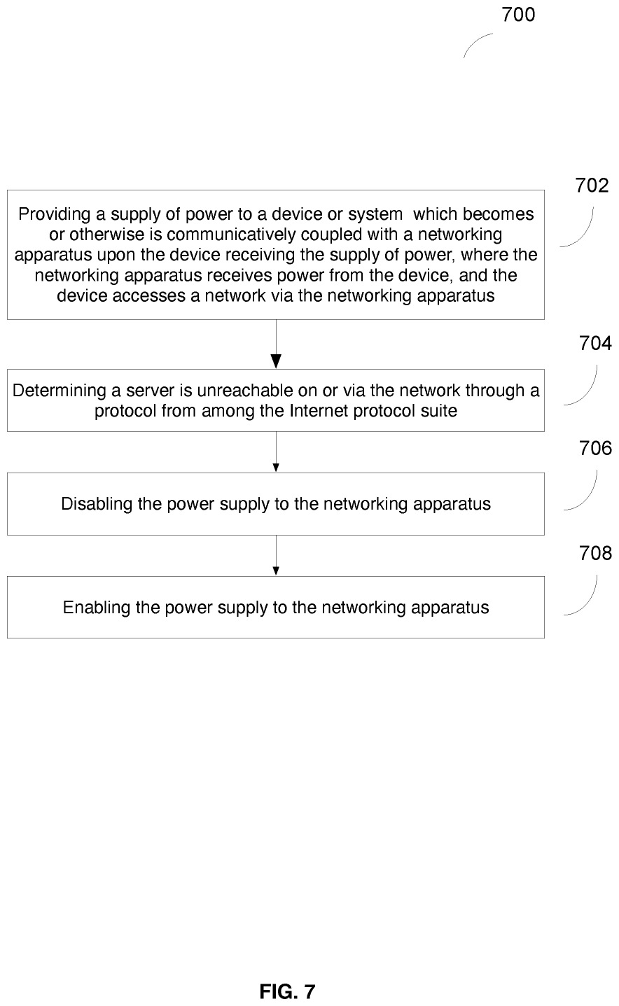

FIG. 7 shows a flow diagram of an exemplary process 700 for network access recovery in accordance with an embodiment of the present invention. A device or system embodying the present invention or otherwise equipped with the present invention, such as one shown in FIG. 1, FIG. 2, and/or FIG. 3, may carry out, implement, or otherwise effect this exemplary process. Per the example process 700, a supply of power is provided to such a device or system which becomes or otherwise is communicatively coupled with a networking apparatus upon the device receiving the supply of power, where the networking apparatus receives power from the device, and the device accesses a network via the networking apparatus (702). For instance, a device or system (e.g., a power bar) equipped with one or more aspects of the present invention may comprise an Ethernet interface such as an Ethernet port. A compatible communication cable or line may connect between this Ethernet interface and a port on a modem or router whose electrical plug is inserted in or otherwise attached to an electrical power outlet on the power bar. When the device or system receives power from a power source, e.g., an AC Main supply, it not only powers up the modem or router, but subsequently has access to the network of interest via the modem or router, all the while without the device or system needing any custom configuration or setup information in order to access the network.

Per the example process 700, the device or system may determine a server is unreachable on or via the network through a protocol from among the Internet protocol suite (704). For instance, based on factory settings or factory-set configuration information (e.g., server IP addresses or URLs) stored in one or more non-volatile memories that it may retrieve without the need to access the network being monitored, the device or system may send an IP (Internet protocol)-based (e.g., HTTP, ICMP) request or message to a pre-determined server on the network through the modem or router communicatively coupled with the device or system via the Ethernet interface. When the device or system fails to receive a response after a pre-defined period of time, e.g., as stored in and retrievable from factory settings or factory-set configuration information, it may determine that the network access is unacceptable.

Per the example process 700, the device or system may disable the power supply to the networking apparatus (706). For instance, the device or system may disable the power outlet with or to which the modem or router is supplied power or plugged.

Per the example process 700, the device or system may enable the power supply to the networking apparatus (708). For instance, the device or system may turn on again the power outlet to the modem or router. In one embodiment, based on factory settings or factory-set configuration information (e.g., time interval information) stored in one or more non-volatile memories that it may retrieve without the need to access the network being monitored, the device or system may re-enable the power outlet after a time interval.

It should be appreciated that the specific steps illustrated in FIG. 7 provide an illustrative method of performing network access monitoring and recovery. One of ordinary skill in the art would readily be able to apply or otherwise modify it for use among different devices or systems or their setups.

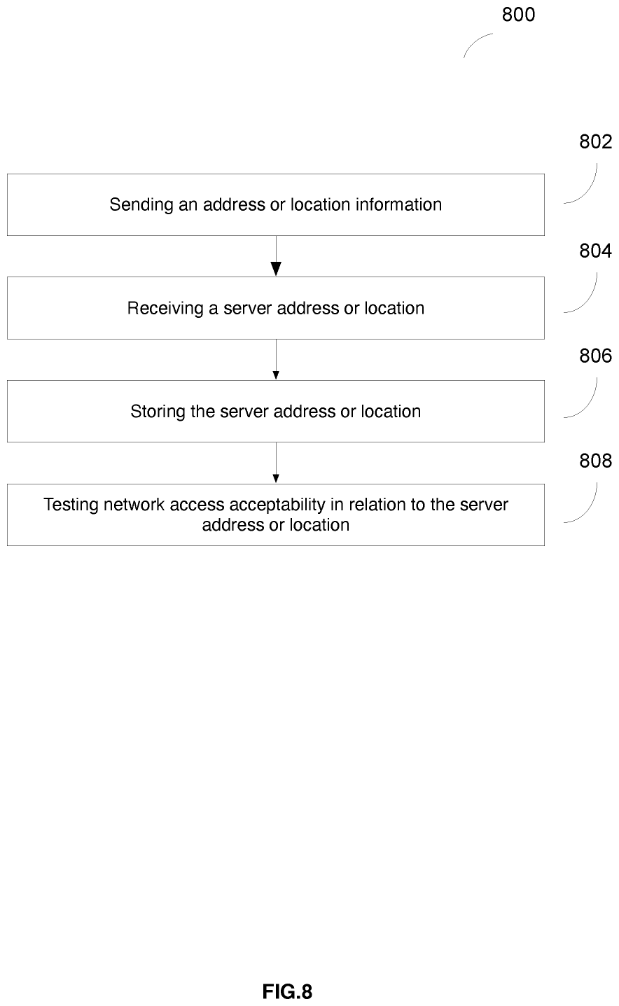

FIG. 8 shows a flow diagram of an exemplary process 800 for network access recovery in accordance with an embodiment of the present invention. A device or system embodying the present invention or otherwise equipped with the present invention, such as one shown in FIG. 1, FIG. 2, and/or FIG. 3, may carry out, implement, or otherwise effect this exemplary process. Per the example process 800, such a device or system may send an address or location information (802). For instance, the device or system may obtain an IP (Internet Protocol) address from a networking apparatus that the device or system is communicatively coupled with, and through which it may access the network being monitored. The device or system may provide the IP address either implicitly as a source location of a message to an external server, or explicitly as a dedicated message to the external server. In one example, the address or location of the external server is part of the factory settings or factory-set configuration information (e.g., server IP addresses or URLs) stored in one or more non-volatile memories that the device or system may retrieve without the need to access the network being monitored.

Per the example process 800, the device or system may receive a server address or location (804). For instance, the device or system may receive from the external server an IP address or URL for a different server that the device or system may use for subsequent network access acceptability tests, for example, due to its geographical proximity to the device or system. In one embodiment, such IP addresses or URLs for performing network access acceptability tests may be obtained through a process known as IP Geolocation, which may be available via an IP address database or IP Geolocation Services accessible via the Internet by means of API (Application Programming Interface).

Per the example process 800, the device or system may store the server address or location (806). For instance, the device or system may store the IP address or URL for the different server in one or more non-volatile memories that it has access to.

Per the example process 800, the device or system may test network access acceptability in relation to the server address or location (808). For instance, the device or system may send periodically an IP-protocol based message or request to the different server until it fails to receive a response within a pre-determined time period. When such failure is detected, it may cause one or more power supplies to be unavailable or insufficient, thereby initiating a network access recovery process.

It should be appreciated that the specific steps illustrated in FIG. 8 provide an illustrative method of performing network access monitoring and recovery. One of ordinary skill in the art would readily be able to apply or otherwise modify it for use among different devices or systems or their setups.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. For instance, method steps described herein may be performed in alternative orders or in parallel. Various embodiments of the invention include logic stored on computer readable media, the logic configured to perform methods of the invention. The examples provided herein are exemplary and are not meant to be exclusive.

For instance, while the present invention has been described in connection with the preferred aspects, as illustrated in the various figures, it is understood that other similar aspects may be used or modifications and additions may be made to the described aspects for performing the same function of the present disclosure without deviating there from. Therefore, the present disclosure should not be limited to any single aspect, but rather construed in breadth and scope in accordance with the appended claims. For example, the various procedures described herein may be implemented with hardware or software, or a combination of both. The invention may be implemented with non-transitory computer-readable storage media and/or computer-readable communication media. Computer programs incorporating various features or aspects of the present invention, or portions thereof, may be encoded on various computer readable media for storage and/or transmission, or take the form of program code (i.e. instructions) embodied in a tangible media; suitable media include magnetic disk or tape, optical storage media such as compact disk (CD) or DVD (digital versatile disk), flash memory, hard drive, and any other machine-readable storage medium. Computer readable media encoded with the program code may be packaged with a compatible device or provided separately from other devices (e.g., via Internet download). Likewise, the invention, or certain aspects or portions thereof, may be embodied in propagated signals, or any other machine-readable communications medium. Where the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only. Thus, although the invention has been described with respect to specific embodiments, it will be appreciated that the invention is intended to cover all modifications and equivalents within the scope of the following claims.

What is claimed:

1. A computer-implemented method, comprising:
determining, by a device, that accessibility to or via a network is unacceptable in relation to a criterion;
causing, by the device, a power supply to be unavailable or insufficient; and
causing, by the device, the power supply to be available or sufficient.

2. The method of claim 1, wherein said criterion is stored in one or more memories prior to causing the power supply to be unavailable or insufficient, and the device comprises one or more memories.

3. The method of claim 1, further comprising:
receiving, by the device, an indication of configuration information from a host or server on the Internet, wherein said configuration information comprises said criterion;
determining, by the device independently of accessibility to the network, that a period of time has passed;
determining, by the device independently of accessibility to the network, that accessibility to the network is unacceptable after said period of time;
causing, by the device independently of accessibility to the network, the power supply to be unavailable or insufficient for another period of time; and
causing, by the device independently of accessibility to the network, the power supply to be available or sufficient after said other period of time.

4. The method of claim 1, further comprising:
wherein the device comprises two or more power outlets; and
wherein causing the power supply to be available or sufficient comprises causing a power outlet from among the two or more power outlets to be available or sufficient after a period of time, and causing another power outlet from among the two or more power outlets to be available or sufficient after another period of time, said other power outlet being available or sufficient after said power outlet being available or sufficient.

5. The method of claim 1, wherein determining that accessibility to or via the network is unacceptable comprises determining, by the device, that a download or upload speed to or via the network is lower than another speed, wherein the other speed is determined in relation to percentage information, said percentage information is stored in one or more memories, and the device comprises the one or more memories.

6. The method of claim 1, further comprising:
receiving, by the device, a supply of power, the device being communicatively coupled with a networking apparatus upon the device receiving the supply of power, wherein the network apparatus is associated with access to the network, the network apparatus receives power from one or more electrical outlets, and the device comprises the one or more electrical outlets;
wherein determining that accessibility to or via the network is unacceptable comprises determining, by the device, that a server is unreachable via a protocol from among the Internet protocol suite, wherein a first time interval exists between the device receiving the supply of power and the device determining that the server is unreachable;
wherein causing the power supply to be unavailable or insufficient comprises disabling, by the device, the one or more electrical outlets;
wherein causing the power supply to be available or sufficient comprises enabling, by the device, the one or more electrical outlets;
waiting, by the device, a second time interval, wherein the second time interval is longer than the first time interval;
determining, by the device, that the server or another server is unreachable via the protocol or another protocol from among the Internet protocol suite;
disabling, by the device, the one or more electrical outlets; and
enabling, by the device, the one or more electrical outlets.

7. The method of claim 1, further comprising:
determining, by the device, a speed to or via the network;
receiving, by the device, an indication that accessibility to or via the network is acceptable;
storing in one or more memories, by the device, speed information in relation to the speed; and
wherein determining that accessibility to or via the network is unacceptable comprises determining, by the device, that an access speed to the network is lower than or same as another speed, and said other speed is determined in relation to said speed information.

8. The method of claim 1, further comprising:
wherein the device comprises an electrical outlet;
wherein determining that accessibility to or via the network is unacceptable comprises determining, by the device, that the Internet is not accessible via a Wi-Fi network;
wherein a modem or router is plugged into said electrical outlet, and the modem or router enables the device to access the Internet via the Wi-Fi network;
wherein causing a power supply to be unavailable or insufficient comprises disabling said electrical outlet; and
wherein causing the power supply to be available or sufficient comprises enabling said electrical outlet in relation to a time interval, wherein the time interval is determined in relation to time information, said time information is stored in one or more memories, and the device comprises the one or more memories.

9. The method of claim 8, wherein determining that the Internet is not accessible via the Wi-Fi network comprises determining, by the device, that a host on the Internet is not reachable via the Wi-Fi network through a protocol from among the Internet protocol suite.

10. The method of claim 3, further comprising:
wherein said third period of time is longer than said period of time;
determining, by the device, that a fourth period of time has passed;
determining, by the device, that accessibility to the network is unacceptable after said fourth period of time;
causing, by the device, the power supply to be unavailable or insufficient for a fifth period of time, wherein said fifth period of time is longer said the third period of time; and
causing, by the device, the power supply to be available or sufficient after said fifth period of time.

11. The method of claim 1, further comprising:
receiving, by the device, an indication of server or host information;
storing the server or host information in one or more memories, wherein the device comprises the one or more memories; and
wherein determining that accessibility to or via the network is unacceptable comprises determining, by the device, that a download or upload speed to one or more servers or hosts on or via the network is unacceptable, wherein said one or more servers or hosts are associated with the server or host information.

12. The method of claim 1, further comprising:
wherein the device comprises two power outlets, a power outlet from among the two power outlets is associated with an identifier on the device, another power outlet from among the two power outlets is associated with another identifier on the device, and said identifier signifies sequentially sooner than said other identifier; and
wherein causing the power supply to be available or sufficient comprises causing said power outlet to be available or sufficient after a period of time, and causing said other power outlet to be available or sufficient after another period of time, said other power outlet being available or sufficient after said power outlet being available or sufficient.

13. The method of claim 1, further comprising:
wherein the device comprises two power outlets, a power outlet from among the two power outlets is associated with a visual indicator on the device, another power outlet from among the two power outlets is associated with a tactile input receiving mechanism, and the device comprises the tactile input receiving mechanism;
activating, by the device, the visual indicator to signify on or active in relation to said power outlet being enabled;
receiving, by the device, an indication via the tactile input receiving mechanism;
determining, by the device, time or duration information in relation to the indication;
storing in one or more memories, by the device, a wait time in relation to the time or duration information;
wherein causing a power supply to be unavailable or insufficient comprises disabling, by the device, said power outlet and said other power outlet; and
wherein causing the power supply to be available or sufficient comprises enabling, by the device, said power outlet after a period of time, and enabling, by the device, said other power outlet after another period of time, wherein said other period of time is determined in relation to said wait time.

14. The method of claim 1, further comprising:
wherein the device comprises two power outlets, a power outlet from among the two power outlets is associated with an identifier, another power outlet from among the two power outlets is associated with another identifier, and said identifier signifies sequentially sooner than said other identifier;
receiving, by the device, an indication associated with said identifier, and another indication associated with said other identifier; and
wherein causing the power supply to be available or sufficient comprises causing said power outlet to be available or sufficient after a period of time, and causing said other power outlet to be available or sufficient after another period of time, said other power outlet being available or sufficient after said power outlet being available or sufficient.

15. The method of claim 1, further comprising:
causing, by the device, another power supply to be unavailable or insufficient;
determining, by the device, that accessibility to the network is acceptable; and
causing, by the device, said other power supply to be available or sufficient in relation to determining that accessibility to the network is acceptable.

16. The method of claim 1, further comprising:
receiving, by the device, address or location information in relation to one or more servers or hosts;
storing, by the device, in one or more memories, information for access to at least one server or host from among the one or more servers or hosts on or via the network, wherein the information for access is associated with the address or location information; and
determining, by the device, said criterion in relation to a speed, wherein the speed is associated with access to said at least one server or host.

17. The method of claim 16, further comprising:
wherein the device comprises a first power outlet and a second power outlet; and
causing the power supply to be unavailable or insufficient comprises disabling, by the device, the first power outlet and the second power outlet; and
causing the power supply to be available or sufficient comprises enabling, by the device, the first power outlet after a first period of time, and the second power outlet after a second period of time, the second power outlet being enabled after the first power outlet being enabled.

18. The method of claim 1, further comprising:
receiving, by the device, one or more indications of configuration information; and
storing, by the device, in one or more memories, information for said criterion, wherein said information for said criterion is associated with said one or more indications of configuration information, and the device comprises the one or more memories.

19. A system, comprising:
one or more processors; and
one or more memories communicatively coupled to the one or more processors when the system is operational, the one or more memories beating processor-executable instructions that, when executed by the one or more processors or on the system, cause the system at least to:
determine that accessibility to or via a network is unacceptable in relation to a criterion;
cause a power supply to be unavailable or insufficient; and
cause the power supply to be available or sufficient.

20. A non-transitory computer-readable storage medium bearing computer-readable instructions that, when executed on a device, cause the device to perform operations comprising:
determining that accessibility to or via a network is unacceptable in relation to a criterion;
causing a power supply to be unavailable or insufficient; and
causing the power supply to be available or sufficient.
